(19) United States
(12) Patent Application Publication
(10) Pub. No.: US 2011/0099119 A1
(43) Pub. Date: Apr. 28, 2011

(54) SYSTEM AND METHOD FOR PUSHING NOTIFICATIONS OF POSTINGS

(75) Inventors: Richard Alan Kwiat, Boulder, CO (US); James Michael Robertson, Jupiter, FL (US)

(73) Assignee: MOBILE IMAGINATION, LLC., Boulder, CO (US)

(21) Appl. No.: 12/913,578

(22) Filed: Oct. 27, 2010

Related U.S. Application Data
(60) Provisional application No. 61/255,274, filed on Oct. 27, 2009.

(51) Int. Cl. G06Q 10/00

(52) U.S. Cl. 705/321

(57) ABSTRACT

A system and method for the generation and distribution of a job notification The method includes receiving geographic information for a shoot location. A job posting is generated that is associated with a production shoot held at the shoot location on a particular date. A user selected search parameter is determined that is associated with the geographic information. One or more listings are accessed from a directory of listings, each of which corresponds to an entity providing products or services related to the job posting. The accessing of listings is based on the geographic information and the user selected search parameter. A notification of the job posting is generated and pushed to one or more network access devices associated with the one or more listings.

### CROSS REFERENCE TO RELATED APPLICATIONS

The present application claims priority to and the benefit of U.S. Provisional Patent Application No. 61/255,274, entitled “Electronic Interactive Call Sheet and Push Job Notification,” filed on Oct. 27, 2009, which is herein incorporated by reference in its entirety. The present application is related to U.S. patent application Ser. No. ______, entitled “System And Method For The Generation And Distribution Of An Electronic Interactive Call Sheet,” filed on Oct. 27, 2010, and with the same inventors, which is herein incorporated by reference in its entirety.

### BACKGROUND OF THE INVENTION

1. Field of the Invention

The present invention relates to distributing information used in the production industry and more specifically to the generation and distribution of notifications of a job posting through a communication network.

2. The Relevant Technology

The production industry operates to create multimedia content for news, advertising, performing arts, film, radio, and television. During a production cycle, the production shoot is the period where the content is created. As an example, when producing a film, a production shoot involves the filming of a particular scene that is later incorporated with other scenes to make the film.

Planning for a production shoot may be quite complex, depending on the number of persons involved and what type of content is being created. Even a shoot that is onsite for 6-8 hours will involve multiple entities providing talent, products, and services. For instance, the cast and crew and the various services necessary to support the production shoot need to be prearranged in order to facilitate a successful shoot. Also, last minute searches for resources may be necessary. As examples, some considerations for services may include, in part, set construction, arranging for hotel accommodations, food, transportation, and medical services.

Finding those resources may be quite difficult, especially when the production shoot is occurring in an area not normally used by a production company, or there are difficult time constraints added. For instance, a large production shoot may be filming in a remote location, but is still requiring the full complement of cast, crew, and resources. While in most cases, it may be desirous to bring in talent and resources, it may make sense to utilize local talent and resources whenever possible. This is especially the case when a scheduled crew member falls ill during the production shoot, and the production manager is seeking a replacement. However, finding those resources is difficult, especially for a manager that is not familiar with the area.

It is desirous to explore ways to facilitate the management of a production cycle.

### SUMMARY OF THE INVENTION

The present invention relates to the field of managing the development and production of multimedia, to include, in part, news segments, performing arts, advertising, film, radio, or a television program. Specifically, embodiments of the present invention relate to the pushing of job postings, and more particularly the pushing of notices of the job postings, to interested and relevant parties.

In one embodiment, a method for pushing a posting, and more particularly, pushing a notice of a posting is disclosed. The method includes receiving geographic information. The information is related to a location relevant to the posting, wherein the fulfillment of the posting occurs near the location. For instance, the geographic information may be a user's location, a third party's location, or a location of a production shoot. A posting is generated, wherein the posting may be of any format, but in general passes information, such as a request for talent or resources. The posting may be in the form of a job posting, a posting for resources (e.g., services, production equipment, transportation, hotel services, etc.), a posting for information, a message posting, etc. A user selected search parameter is determined that is associated with the geographic information. The parameter is used as a filter to focus the search for entities providing resources addressing the posting. One or more listings able to address the posting are accessed from a directory of listings. More specifically, the directory includes listings of entities providing products or services relevant to the production industry, and in one embodiment is managed by a central platform. In particular, the directory is maintained so that any need arising during a production shoot can be addressed by a listing in the directory. The accessing of listings is based on the geographic information previously described and the user selected search parameter. A notification of the posting is generated and pushed to one or more network access devices associated with the one or more listings.

In another embodiment, a method for pushing a job posting, and more particularly the pushing of a notice of the job posting, is disclosed. The method includes receiving geographic information for a shoot location. A job posting is generated that is associated with a production shoot held at the shoot location on a particular date. For instance, the job posting may be for a need to fill a cast or crew position. A user selected search parameter is determined that is associated with the geographic information. One or more listings able to fill the job posting are accessed from a directory of listings. More specifically, the directory includes listings of entities providing products or services relevant to the production industry. In particular, the directory is maintained so that any need arising during a production shoot can be addressed by a listing in the directory. The accessing of listings is based on the geographic information and the user selected search parameter. A notification of the job posting is generated and pushed to one or more network access devices associated with the one or more listings.

In another embodiment, a platform for distributing notices of a posting is disclosed. The platform is accessed through a communication network. For instance, the platform may be accessed through a mobile computing device through a telecommunication network, or through any computing resource able to communicate with the platform through any communication network (e.g., internet). The platform includes a directory that includes a plurality of listings of entities providing products or services related to the production industry. That is, the directory is maintained by the platform as a resource for products and services that are needed to support the production industry, especially during a production shoot. The system includes a posting editor for generating a posting, wherein the posting may be of any format, but in general is passing information, such as a request for talent or resources. In particular, the posting may be in the form of a job posting, a posting for resources, a posting passing along or requesting information, a message posting, etc. A user selected search parameter helps to focus the search for resources (e.g., talent, crew, support services, equipment, products, etc.) addressing the posting. Geographic information is used to focus the search for talent or resources addressing the posting. In addition, the system includes a recruiting engine for collecting one or more listings related to the posting from the directory based on the geographic information and the user selected search parameter. Also, a distributor is included for pushing a notification of the posting to one or more network access devices associated with the one or more listings.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is an illustration of a system including a central platform that is capable of supporting the pushing of a notification, such as a job notification, in accordance with one embodiment of the present invention.

FIG. 2 is a block diagram of a back-end server 200 that includes the central platform, in accordance with one embodiment of the present invention.

FIG. 3 is a diagram illustrating a flow chart 300 disclosing a method for pushing a notification, such as a job notification, in accordance with one embodiment of the present invention.

FIG. 4 is an illustration of an exemplary job posting, in accordance with one embodiment of the present invention.

FIG. 5 is a diagram of a display interface 500 showing one or more categories of listings from which to recruit one or more listings, in accordance with one embodiment of the present invention.

### DETAILED DESCRIPTION OF THE PREFERRED EMBODIMENTS

Reference will now be made in detail to the preferred embodiments of the present invention, to include a system and method for the pushing of notifications or notices of a posting, such as a job posting within the production industry. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention as defined by the appended claims.

Accordingly, embodiments of the present invention provide for a central platform that facilitates the pushing of notices of a posting, such as a job posting. Still other embodiments provide the above advantage, and further provide a management tool for industries that operate in the field, such that instant access and communication with various resources and needs to organize various entities, resources, and locations around a specific project, job, or production shoot is provided. Other embodiments of the present invention provide the above advantages, and further provide for bringing together one party that needs talent and/or resources, and another party that is able to provide the talent and/or resources needed. Still other embodiments provide the above advantages, and further provide for the pushing of messages to various parties listed in a directory of listings relevant to the production industry.

While embodiments of the present invention are well suited for the pushing of notices and/or notifications of a job posting to potentially interested entities, other embodiments of the present invention are well suited to the pushing of a posting that passes on information, or makes requests for information or talent/resources in general. In one implementation, embodiments of the present invention are suitable for pushing notices of postings related to crew and resource management for television crews operating at remote sites away from their home studio. In other implementations, embodiments of the present invention are suitable for pushing notices of postings related to the resource management of any project, such as a production shoot, etc.

### Notation and Nomenclature

Embodiments of the present invention can be implemented on software running on a computer system. Other embodiments of the present invention can be implemented on specialized or dedicated hardware running on a computer system, or a combination of software and hardware running on a computer system. The computer system can be a personal computer, notebook computer, server computer, mainframe, networked computer, handheld computer, personal digital assistant, workstation, and the like. This software program or its corresponding hardware implementation is operable for the pushing of a posting to interested parties or entities. In one embodiment, the computer system includes a processor coupled to a bus and memory storage coupled to the bus. The memory storage can be volatile or non-volatile and can include removable storage media. The computer can also include a display, provision for data input and output, etc.

Some portions of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “determining,” “accessing,” “receiving,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

Further, throughout the Application, the term “database” may be used to describe a location for storing information or data, and/or a mechanism for storing information or data. As such, “database” is interchangeable with the following terms: storage, data store, etc.

### Pushing Notifications of Postings

Embodiments of the present invention will enable the production industry, as well as other industries, to push notices to interested entities or parties. For instance, job notices detailing employment opportunities are pushed to entities that may be potentially interested in the notice. Those entities are determined from a directory of listings, from lists of favorites and recents listings of the directory that are associated with a user, from within geographic parameters of a particular location (e.g., range, zip code, city, region), a given distance from a user's current or defined location, or based on a rating system native to the directory.

For purposes of illustration, embodiments of the present invention are described within the context of pushing notices (e.g., job notices) to entities related to the production industry, and in particular for addressing a need for resources in the management of a production shoot. For example, in the management of a production shoot, a production manager seeks to find a camera operator to operate a camera at the direction of the cinematographer. In one illustrated case, embodiments of the present invention are able to search for capable camera operators and push to them notices of the opportunity of hiring an operator, so that a production manager is able to fill the position during the planning stages, or during a last minute change (e.g., camera operator becomes sick). However, it is intended that other embodiments of the present invention are well suited to the pushing of notices for facilitating the management of any project within any industry.

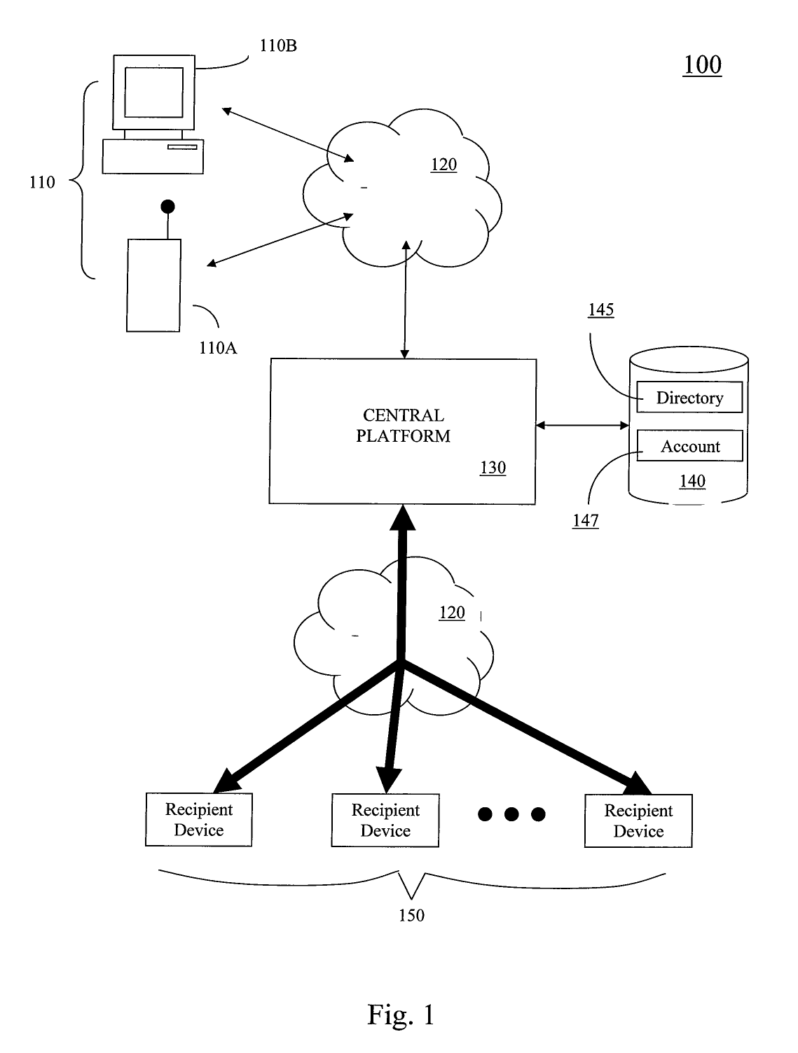

FIG. 1 is an illustration of a system 100 including a central platform 130 that is capable of pushing notices of postings, such as job postings, to interested entities, in accordance with one embodiment of the present invention. The system 100 allows a user to generate a posting, and facilitates the distribution of notices of the posting to interested entities.

As shown in FIG. 1, a user is associated with various network access devices 110 for purposes of generating and distributing a posting. Within the context of the production industry, the user may be a production manager, director, or assistant director that is responsible for the procurement and management of various resources (e.g., cast, crew, support staff, materials, equipment, services, etc.) on a production shoot.

For instance, in the production industry, a production shoot is managed to create multimedia content for news, advertising, performing arts, film, radio, and television. As an example, when producing a film, a production shoot involves the filming of a particular scene that is later incorporated with other scenes to make the film. The production shoot requires many resources to include providing cast, crew (director, assistant director, cinematographer, photographer, production manager, gaffer, etc.), as well as other support staff. In addition, it can be imagined that other resources are needed, similar to those that are needed to run a small office, or town (e.g., office supplies, telecommunication resources, transportation equipment or services, hotel services, hospitality services, etc.). Successful obtention of all of these resources, either before or during a production shoot is necessary to enable a successful production shoot. Embodiments of the present invention are able to generate and distribute notices of postings making one or more requests for those resources to interested entities that are able to fulfill those needs.

In particular, the user is associated with a mobile device 110A (e.g., phone or computer resource) that is capable of accessing a communication network 120 to communicate with various back end servers supporting the pushing of postings. In that manner, the user is able to generate and distribute a posting while on-the-go, and is not tied to a single location. Of course, the user is also associated with other computing resources 110B that are more static in nature, such as a stand-alone computer, that are also capable of accessing the communication network 120 to communicate with the various back end servers that facilitate the generation and distribution of postings.

As a result, the user is able to use a variety of computing resources in the generation and distribution of postings, and more particularly for distributing notices of job postings to interested parties. For instance, the user may start the process on the mobile device 110A, and finish the process on the stand-alone computer 110B, or any combination thereof.

The communication network 120 allows for communicative coupling of the user to various back end servers to facilitate the generation and distribution of the postings. For instance, the communication network is the internet that allows the user to interface with various web servers supporting the generation and distribution of notices of a posting. In another instance, the communication network is any telecommunications network (e.g., a mobile phone network) that allows the user to interface with back-end servers.

System 100 also includes a central platform 130 that is used for the generation and distribution of postings. Specifically, a user accesses the central platform 130 to generate or deliver a posting, and to request or manage the distribution of the posting to various recipients that are interested in receiving the posting, such as those that are interested in fulfilling a request for products or services outlined in a posting. For instance, a posting by a user may include a request to fill a camera operator position for a production shoot held on particular date, or may be a request for information regarding the best camera repair center in a city. In general, the central platform 130 gives the user the ability to generate and distribute postings from their mobile device (e.g., smart phone, mobile computing resource, etc.), or online through a network access device, and distribute that posting to interested parties.

The system also includes a data store 140 that includes a directory 145. The directory 145 includes listings for entities that provide products and/or services that support the production industry. For instance, actors may have a listing in the directory 145. Crew members may also provide their listing in the directory 145. Crew members include those individuals that are involved in producing the multi-media content, such as a camera operator, hair and makeup expert, costume designer, sound designer, construction coordinator, sound mixer, grip, gapher, etc. to name a few. In addition, other vendors that supply essential products and services supporting a production shoot are also listed in the directory 145. For instance, restaurants, hotels, beauty supplies, rental equipment suppliers, office suppliers, etc. may provide a listing within the directory 145. All of these entities associated with the listings are potentially interested in a posting by a user, and embodiments of the present invention facilitate the bringing together of two parties through the pushing of notices (e.g., notice of a job posting) from a user generating the posting to interested parties, such as those having listings in the directory 145.

In essence, the directory 145 is a specialized collection of information relevant to the production industry. Those in the production industry can access the directory 145 to obtain all the information regarding resources necessary to staff and run a production, and more specifically a production shoot. As such, a production company can access the listings in the directory 145 to find individuals necessary to man the cast and crew, as well as all support resources, in an effort to manage a production shoot.

In addition, the data store 140 includes information related to the account record 147 of the user to facilitate the generation and distribution of the posting. For instance, the account record 147 stores postings generated by the user, as well as favorite listings in the directory preferred by the user, and recent listings accessed by the user from the directory.

Further, the central platform 130 facilitates the distribution of the posting to various recipients or entities that are interested in the posting, and more particularly are able to fulfill requests made within the posting (e.g., job opportunities, requests for products or services, etc.). More specifically, central platform 130 is able to push a notice of a posting to various devices 150 associated with corresponding recipients/entities associated with listings in the directory 145.

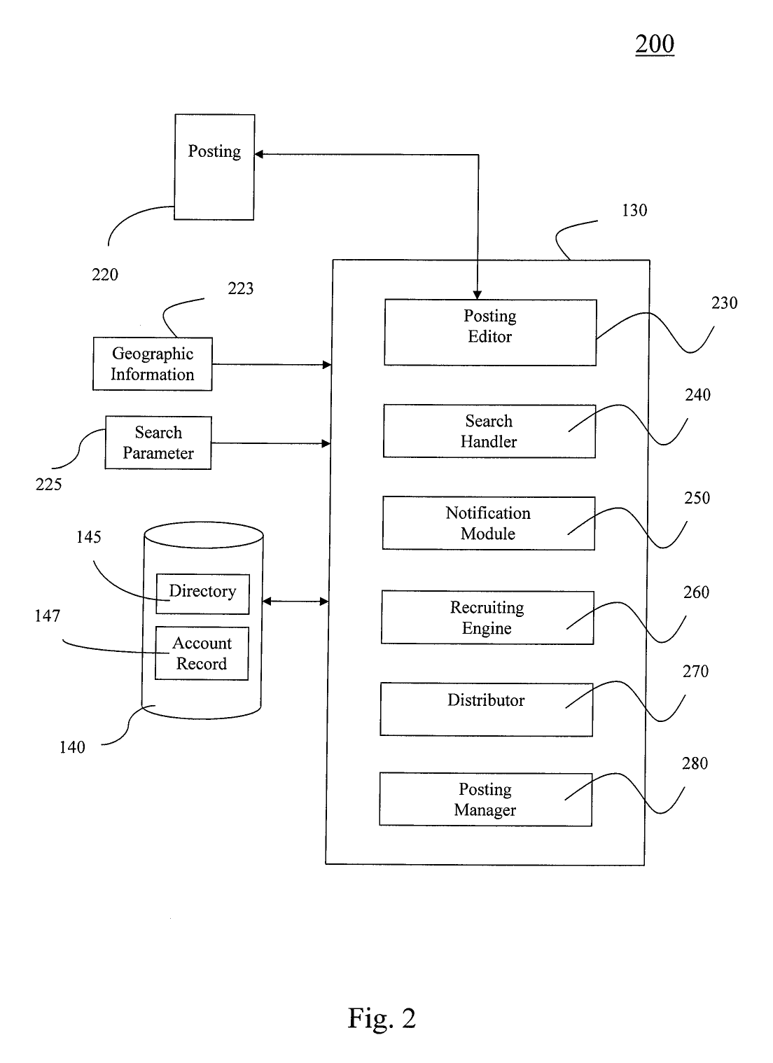

FIG. 2 is a block diagram of a back-end server 200 that includes the central platform 130, in accordance with one embodiment of the present invention. The back-end server 200 provides the functions and features that support the generation and distribution of a posting by a user of the system 200.

While certain features of the central platform 130 are shown as located at the back end server 200, it is important to note that other embodiments of the present invention are well suited to placing those features on the computing resource associated with the user generating a posting. That is, various features involved in the generation and distribution of the posting may be performed, independently, or in parallel, or in support of the back end server, by the local computing resource associated with the user. In still other embodiments, various features involved in the generation and distribution of the posting may be performed both by the local computing resource as well as the back-end server. For instance, the generation of a posting may occur at a local resource associated with the user, and passed to the central platform 130 after generation.

As shown in FIG. 2, system 200 includes the data store 140 that includes the directory 145 as well as the account record 147, as previously described. For instance, the directory 145 includes a plurality of listings of various entities providing products and/or services relevant to the production industry. That is, the directory 145 is a special directory, such as a production guide contacts data base, containing only listings related or relevant to the production industry, and more especially to supporting a production shoot. In addition, a posting 220 is shown as being generated by or delivered to the central platform 130 and stored in data store 140, and more specifically, being stored in association with account record 147.

As previously described, system 200 includes central platform 130 that is accessed by the user to facilitate the generation and distribution of a posting, and more particularly to the generation and distribution of notices of a posting. The central platform 130 includes a posting editor 230 that interfaces with the user, for purposes of generating or receiving a posting 220.

In addition, a search handler 240 obtains search parameters from the user. In one embodiment, geographic information is obtained from the user as a search parameter. The geographic information pertains to a location from which to start the process of the distribution of a posting to interested parties. For instance, the geographic information may pertain to a user's location, or more specifically, the location of the device associated with the user; a location defined by a user; a location of a third party; a location of a production shoot, etc. As an example, the geographic information may pertain to a production shoot location related to a posting that is requesting last minute services for a camera operator for a production shoot in process. This location may be expressed as a geographic location, such as in degrees latitude and longitude.

In another embodiment, a user selected search parameter 225 is obtained by the search handler 240 from the user to further filter the listings of entities interested in or recruited for receiving a posting 220. More specifically, the user selected search parameter 225 includes a definition of a range of distance, radius from a location, a zip code, region definitions to include city/state, categories of entities that may be interested in receiving a posting 220, a list of favorite listings from the directory of a user, a list of recent listings accessed by the user from the directory, etc. In addition, a rating may be provided for filtering the listings. That is, only listings meeting a particular user rating, or a rating defined by a social network of users, such as one generating, distributing, and requesting a posting, are selected for delivery of a posting.

A notification module 250 is included within central platform 130 for generating a notification or notice of the posting. The notice may take on any format, and generally provides notification that a posting 220 is available for viewing to a recipient or entity receiving a notice of the posting 220. The notice may include detailed information regarding the posting 220, medium detailed information regarding the posting 220, or may include minimal information regarding the posting 220.

In addition, central platform 130 includes a recruiting engine 260 for collecting one or more listings related to the posting 220 from the directory 145 based on the geographic information and the user selected search parameter collected. That is, the recruiting engine 260 determines the listings in the directory 145 that would be interested in receiving the job posting using the geographic information and the user selected search parameter. For instance, a recruiting engine 260 aids in the search for a camera operator as outlined in a job posting 220

In one embodiment, the listings recruited are not filtered in that all listings are presented to the user. In other embodiments, the listings are filtered by the user selected location parameter. For instance the parameter may be a cap on the number of listings presented. In another case, the parameter may be defining a maximum distance from the location shoot, such that the individual or entity must be located within the maximum distance from the location shoot. In still other examples, the listings may be located within some upper limit (e.g., 200 miles) of the specified location (e.g., location shoot, user location, contact location, etc.). Of course, the parameter is adjustable, so that listings may be searched from anywhere between 5 to 200 miles, for example.

In still another embodiment, the search parameter defines a zip code from within which to recruit one or more listings. The zip code may be associated with the location shoot. In another embodiment, the location parameter defines a region, city, and/or state within which to generate and search for one or more listings. The city/state may be associated with the location shoot. In one case, if a city is selected, the geographic center of the city is used as a location seed, and contacts within that city are shown. In the case of the state parameter, only contacts in that state are shown to the user for further selection. In one embodiment, this search parameter is used in conjunction with or independently of the geographic information previously provided. For instance, in a search for a camera operator, the recruiting engine 260 may provide a list of all camera operators that list their corresponding locations within a distance range of a production shoot, or within a zip code that is near the location of the production shoot.

In still another embodiment, the search parameter defines a list of favorites in the directory 145 associated with the user, or a list of recent listings accessed by the user from the directory 145. Also, listings from the favorites and/or recents features may be grouped by one or more categories. For instance, the user may only be interested in recruiting listings for a single category, or in another instance, the user has a full cast and crew ready for any production shoot, and is able to pull that information either from the favorites or recents listings. In addition, the favorites and/or recents features is associated with the user's account 147 or use of the central platform 130 by the user, in one embodiment. In another embodiment, the favorites and/or recents features is associated with a device of the user. Also, the listing may be added to the contact list associated with the user for the account record 147, or for any device associated with the user.

In another embodiment, the user is able to deliver a posting by listing category. The category is any grouping of products and/or services that support the production industry. In addition, the category may be further defined as a subcategory, thus creating a category/subcategory pair from which listings are recruited. For instance, a category may exist for a production designer, that also contains subcategories for the art department, the art directory, the set designer, the assistant art director, etc. The user is not looking for any specific individual or entity, but is interested in one or more listings of entities or individual that can provide the products and/or services related to the category or subcategory of information. A user that is looking to find an individual providing services under the Camera Operators category is able to utilize the central platform and the recruiting engine 260 to search for relevant listings as provided by the directory 145. In still another embodiment, rather than having the user define the listing category, the recruiting engine may determine the proper listings category for a posting and automatically limit the search to listings in that category.

In another embodiment, a “Near Other Contact” feature provides for the recruiting of one or more listings in relation to another contact, or more specifically listings are provided within a geographic area of another contact, or in compliance with a parameter in association with that contact, or as defined by that contact. For instance, when contacts associated with the user are presented for selection. Upon selection of a selected contact, the contact's zip code, or any other defined parameter by the user or contact, is used as the search parameter. In one case, only listings having the same zip code, and/or surrounding zip codes, as the contact are presented to the user for selection.

In another embodiment, one or more listings are also recruited from the contact list of a device associated with the user. That is, the user may specify that contacts from their device are preferred for recruiting. In addition, the central platform is able to incorporate that contact information into the directory 145.

Also, central platform 130 includes a distributor 270 that is configured for pushing a notification of the posting to the entities associated with the one or more listings as recruited by the recruiting engine 260. More particularly, the notification is pushed to one or more network access devices associated with the one or more listings. In that manner, a notification of a posting is delivered to a preferred network access device of a corresponding entity, such as a mobile phone of the entity, such that the entity is able to immediately receive notice of the posting (e.g., a job posting for a camera operator).

Also shown in FIG. 2 is a posting manager 280 within central platform 130. The posting manager 280 includes a request handler for receiving a request for the posting 220 from an entity receiving a notice of the posting. In particular, the request handler receives the request from a network access device associated with the entity. Thereafter, the distributor 270 delivers the posting to the network access device associated with the entity requesting the posting.

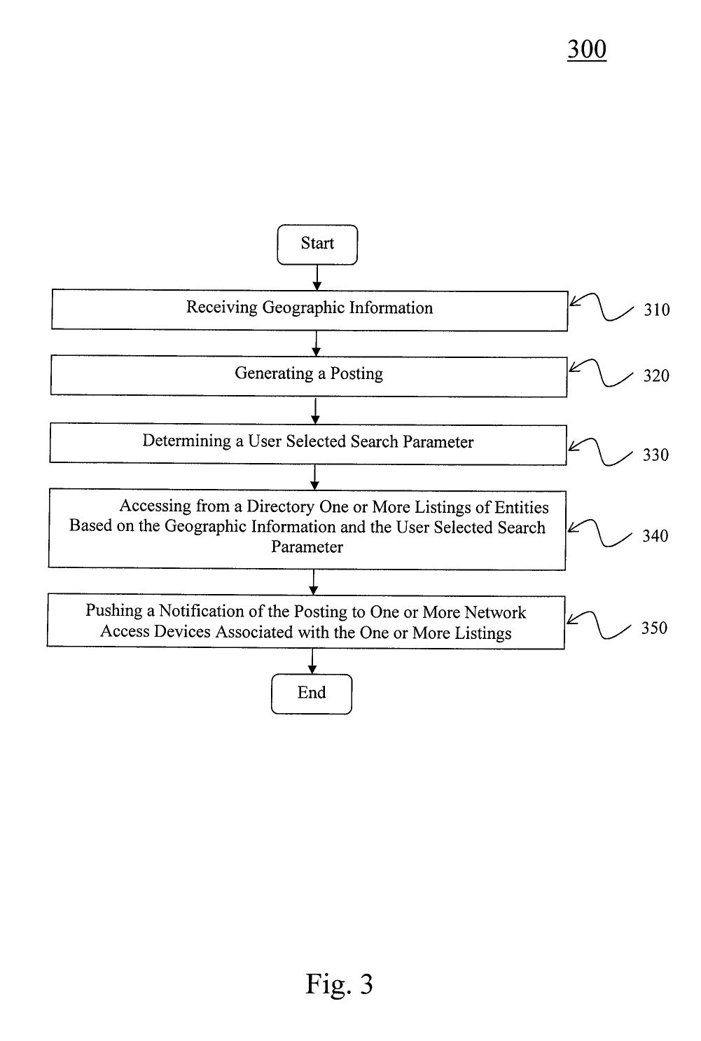

FIG. 3 is a diagram illustrating a flow chart 300 disclosing an overall method for generating and distributing a posting, and more particularly, to the generating and distributing of a notice of the posting to interested and/or recruited parties, such as the generation and distribution of a job posting, in accordance with one embodiment of the present invention. In one implementation, the method is implemented through a central platform for the generation and distribution of postings, such as central platform 130.

For purposes of illustration only, the method in flow chart 300 is described within the context of searching for a camera operator through a job posting for a production shoot to be held at a shoot location, but is intended to be representative of the generation and distribution of any posting that is used for any purpose, such as posting job opportunities, or sending messages.

Continuing with FIG. 3, geographic information is received for a location 310. In one particular implementation, the geographic information is related to a shoot location where a production shoot to be held on a particular date. In other implementations, the geographic information may pertain to a user's location, or any other defined location. The geographic information is in any format suitable for defining a location, such as latitude and longitude coordinates, address, zip code, city/state, etc. The shoot location is where the production or generation of multimedia content occurs. For instance, in the case of a movie film, the shoot location is the area where a scene is captured.

In addition, a posting is generated 320 or received. More specifically, a posting including information is generated by a user. For instance, a posting may be associated with a production shoot held at a shoot location on a particular date, and include an opportunity for a camera operator on a production shoot, and comes in the form of a job posting. Other postings may include a request for information, such as a request to find a suitable camera repair shop in a particular region that is distributed to entities that would have knowledge of that information, such as camera operators within the same region. Other postings may include information in general, such as a message that is posted, and delivered to interested recipients, such as a posting that reviews a particular production crew that is distributed to production managers.

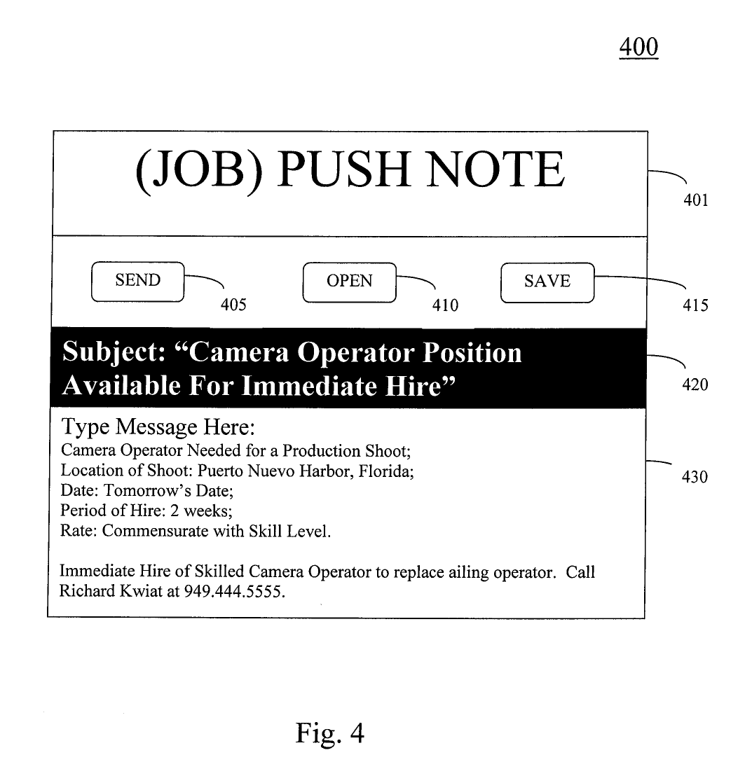

FIG. 4 is an illustration of a posting 400 while it is being generated through central platform 130, in accordance with one embodiment of the present invention. For instance, posting 400 is a “job posting” requesting the skills of a camera operator, as shown in the heading 401. Various interface buttons are presented to the user generating the note, to include a SEND button 405, OPEN another note for generation button 410, and a SAVE the posting button 415.

As shown, the user is able to enter a subject in section 420. For instance, the subject of the posting is “Camera Operator Position Available For Immediate Hire.” As such, any recipient of the posting 400 is able to understand that a camera operator is being requested. In one implementation, a notification of the posting 400 may include only subject matter information, as provided in section 420.

Section 430 allows the user to enter in a message for the posting 400. For instance, details to the hiring of a camera operator are included in section 430, to include: location of shoot, date of hire, duration of hire, and pay rate. Contact information is also included.

Returning back to FIG. 3, a user selected search parameter is determined 330. As previously described, the search parameter filters the recruitment of listings of entities interested in receiving the posting, or for listings that the user wants to direct the posting. These search parameters may operate independently or in conjunction with the geographic information previously determined, in embodiments. For instance, the search parameter includes a definition of a geographic area, in reference to the shoot location, within which to search for listings, such as a range of distance, radius from a location, a zip code, region to include city/state; listing categories of entities that may be interested in receiving a posting 220; a cap on the number of listings recruited; a list of recent listings accessed by the user from the directory; a contact within a contact list in a device associated with the user; a rating of listings in association with the directory, wherein ratings for listings are provided by users of the central platform 130 and the directory 145, etc. Also, the search parameter may define a time period for operation. For instance, it is necessary that information is provided for resources that are able to provide product and/or services in support of the production shoot. For instance, if the production shoot is held on a holiday, after-hours, on a Sunday, then it would be important to provide listings for recruiting that have hours of operation coinciding with the date and time of the production shoot.

In still another embodiment, the search parameter defines a list of favorite listings in a directory as defined by a user (e.g., that responsible for the posting), or a list of recent listings accessed by the user from the directory. In either case, the listings recruited is accessed from the list of favorites or recents.

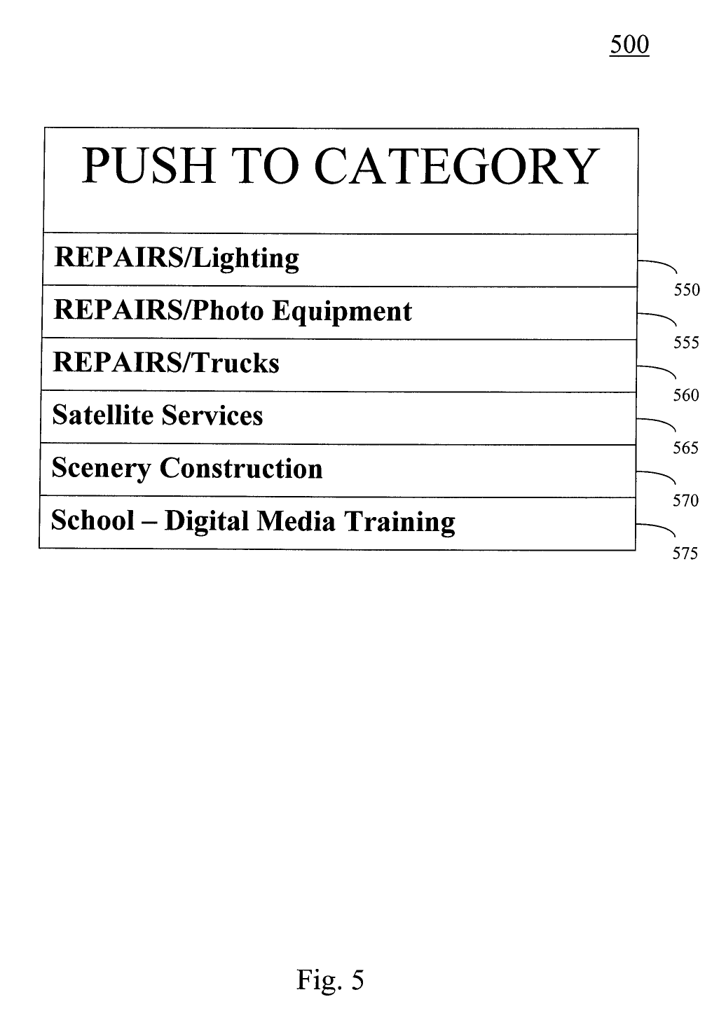

In particular, a listing category is defined as a search parameter, wherein the listings recruited are accessed from the category of listings as presented within a directory. For illustration, FIG. 5 is a diagram of a display interface 500 showing one or more categories of listings from which to recruit one or more listings, in accordance with one embodiment of the present invention. As shown, various categories are shown for selection as a search parameter by a user. For instance, various “REPAIR” categories are listed, including those for “Lighting” 550, “Photo Equipment” 555, and “Trucks” 560. Also, categories beginning with the letter “s” are included, such as those for Satellite Services” 565, “Scenery Construction” 570, and “School-Digital Media Training” 575. In addition, although the selection of categories is listed alphabetically in FIG. 5, the list of categories may be presented in any fashion. Using the example of a job posting for a camera operator, the recruitment of listings is performed from within the listing category of “Camera Operators,” as selected by the user, or determined by the system 200. In that manner, only camera operators listed in the directory will be presented with the opportunity to fill that job posting.

In another embodiment, the user is able to further filter the recruited listings. This may be accomplished through a selection of one or more listings from those originally recruited by the user. For instance, under the category of “Scenery Construction” 570 of FIG. 5, various listings may be presented to the user for further selection on another display interface.

In addition, one or more listings are accessed from a directory 340, wherein the directory includes listings of entities providing products and/or services related to an industry associated with the posting, such as those products and/or services related to the production industry. For instance, the listings are accessed through a data store lookup of the directory 145, or from personal contacts provided by a device associated with the user. In one implementation, the directory 145 is managed by the central platform 130 for purposes of providing listings for recruitment. In addition, the listings that are recruited are defined based on the geographic information (e.g., that of the location shoot) and the user selected search parameter (e.g., radius from a shoot location, a zip code, a city, a region, a state, a rating, etc.).

In addition, a notification or notice of the posting is generated. The notice includes enough information to inform a recipient that a posting is available for viewing, and may include a summary of the what the posting contains, such as a job posting for a camera operator. Also, the notification is pushed to the one or more listings recruited 350. More specifically, the notification is pushed to one or more network access devices associated with the one or more listings previously recruited.

In addition, the posting is stored in a data store. For instance, the posting may be stored in data store 140 of the system 200. Thereafter, a request for the job posting may be received from a recipient of the notification, or more specifically from a network access device associated with the recipient. The posting is then delivered to the network access device associated with the recipient. For instance, in the example of the job posting for a camera operator, specific information contained in the job posting is then delivered to a recipient of the notification of the job posting.

Further, an acceptance of the job posting may be received from the recipient described above. In one embodiment, after acceptance, the job posting is removed from the central platform 130. A status of the job posting is updated to reflect that the job posting has been accepted, whereas previously the status may have reflected that the job posting is active and has been delivered to recruited listings. Additionally, the job posting may be removed from the central platform 130 after a period of time, whether or not an acceptance has been received. In that manner, stale postings are removed from the system, such as system 200.

In one embodiment, the posting may be to a note that is included within a call sheet, or is associated with a call sheet, for a production shoot, wherein the call sheet is used to manage resources needed for a production shoot. For instance, a note or message from the user to one or more targeted recipients may be associated with the call sheet that is delivered to all parties associated with the production shoot. Other recipients of the call sheet are not made aware of the existence of the note.

In particular, the note may be in the form of a posting. As such, a notification of the posting including the note is delivered to one or more targeted recipients by the central platform 130, independent of the delivery of the call sheet. The targeted recipients are defined through the user selected search parameter, in one embodiment. In that manner, the user is able to generate a note in the form of a posting that is in association with a call sheet, store the posting, deliver a notice of the existence of the posting, and deliver the posting/note in response to a request for the posting. For instance, the recipient may communicate with the posting manager 280 to make the request, and in response the posting manager 280 then sends the request to the recipient.

Embodiments of the present invention are well suited to providing notices of postings in support of the management of work crews or a work project for a variety of industries, in addition to the production industry. For instance, the systems and methods outlined in FIGS. 1-5 are well suited to sending out postings requesting products and/or services needed by a work crew in a particular location, or in support of a work project or event being performed in that location. In particular, geographic information is received for a location where the work crew is working, or where a project or event is being held. A posting is generated that is associated with the management of the work crew, project or event (e.g., job posting for a particular service). A user selected search parameter is also determined to focus the accessing of recruited listings from a directory of listings associated with entities providing products and/or services supporting the management of a work crew, project or event. One or more listings are accessed or recruited from the directory based on the geographic information and the user selected search parameter. A notification of the posting is generated and pushed to the one or more recruited listings, and more particularly, pushed to network access devices corresponding to the recruited listings.

A system and method for the generation and distribution of postings, and more particularly to notices of postings (e.g., job postings) is thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

The one or more present inventions, in various embodiments, include components, methods, processes, systems and/or apparatus substantially as depicted and described herein, including various embodiments, subcombinations, and subsets thereof. Those of skill in the art will understand how to make and use the present invention after understanding the present disclosure.

The present invention, in various embodiments, includes providing devices and processes in the absence of items not depicted and/or described herein or in various embodiments hereof, including in the absence of such items as may have been used in previous devices or processes (e.g., for improving performance, achieving ease and/or reducing cost of implementation).

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention (e.g., as may be within the skill and knowledge of those in the art, after understanding the present disclosure). It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed:

1. A method for distributing notices, comprising:
receiving geographic information of a shoot location;
generating a job posting associated with a production shoot held at said shoot location on a particular date;
determining a user selected search parameter;
accessing from a directory one or more listings, each of which corresponding to an entity providing products or services related to said job posting, based on said geographic information and said user selected search parameter; and
pushing a notification of said job posting to one or more network access devices associated with said one or more listings.

2. The method of claim 1, further comprising:
determining a listing category of said directory associated with said job posting; and
wherein said accessing from a directory comprises accessing from said listing category of said directory said one or more listings.

3. The method of claim 1, wherein said user selected search parameter comprises a list of favorite listings in said directory for a user, and wherein said accessing from a directory comprises:
accessing from said list of favorite listings said one or more listings.

4. The method of claim 1, wherein said user selected search parameter comprises a list of recent listings in said directory for a user, and wherein said accessing from a directory comprises:
accessing from said list of recent listings said one or more listings.

5. The method of claim 1, wherein said user selected search parameter is taken from a group consisting essentially of a radius from said shoot location, a zip code, a city, a region, a state, and a rating.

6. The method of claim 1, further comprising:
adding a listing to said one or more listings from a contact list associated with a device of a user responsible for said job posting.

7. The method of claim 1, further comprising:
storing said job posting.

8. The method of claim 7, further comprising:
receiving a request for said job posting from a network access device associated with a recipient of said notification; and
delivering said job posting to said network access device.

9. The method of claim 8, further comprising:
receiving an acceptance of said job posting from said recipient; and
removing said job posting.

10. A system for distributing notices, comprising:
a directory comprising a plurality of listings of entities providing products or services related to the production industry;
a posting editor for generating a posting;
a user selected search parameter;
a geographic information;
a recruiting engine for collecting one or more listings related to said posting from said directory based on said geographic information and said user selected search parameter; and
a distributor for pushing a notification of said posting to one or more network access devices associated with said one or more listings.

11. The system of claim 10, wherein said recruiting engine determines a listing category in said directory associated with said posting, and wherein said one or more listings is collected from said listing category.

12. The system of claim 10, wherein said user selected search parameter is taken from a group consisting essentially of:
a list of favorite listings in said directory for a user;
a list of recent listings in said directory for said user;
a radius from a shoot location;
a zip code;
a city;
a region;
a state; and
a rating.

13. The system of claim 10, wherein said posting comprises a job posting associated with a production shoot held at said shoot location on a particular date;

14. The system of claim 10, further comprising:
a contact from a contact list associated with a network access device of a user responsible for said posting, and wherein said recruiting engine adds said contact to said one or more listings.

15. The system of claim 10, further comprising:
a data store for storing said posting.

16. The system of claim 15, further comprising:
a request handler for receiving a request for said posting from a network access device associated with a recipient of said notification; and
wherein said distributor delivers said posting to said network access device.

17. A method for distributing notices, comprising:
receiving geographic information;
generating a posting;
determining a user selected search parameter;
accessing from a directory one or more listings, each of which corresponding to an entity providing products or services related to said posting, based on said geographic information and said user selected search parameter; and
pushing a notification of said posting to one or more network access devices associated with said one or more listings.

18. The method of claim 17, wherein said receiving geographic information comprises:
receiving said geographic information for a shoot location where a production shoot is held on a particular date.

19. The method of claim 17, wherein said receiving geographic information comprises:
receiving said geographic information for a location of a user.

20. The method of claim 19, further comprising:
receiving GPS information associated with a device of said user as said geographic information.

21. The method of claim 17, wherein said receiving a posting comprises:
receiving a job posting.

22. The method of claim 17, wherein said receiving a posting comprises:
receiving a note posting.

23. The method of claim 17, further comprising:
determining a listing category of said directory associated with said posting; and
wherein said accessing from a directory comprises accessing from said listing category of said directory said one or more listings.

24. The method of claim 17, wherein said user selected search parameter comprises a list of favorite listings in said directory for a user, and wherein said accessing from a directory comprises:
accessing from said list of favorite listings said one or more listings.

25. The method of claim 17, wherein said user selected search parameter comprises a list of recent listings in said directory for a user, and wherein said accessing from a directory comprises:
accessing from said list of recent listings said one or more listings.

26. The method of claim 17, wherein said user selected search parameter is taken from a group consisting essentially of a radius from a shoot location, a zip code, a city, a region, a state, and a rating.

28. The method of claim 26, further comprising:
adding a listing to said one or more listings from a contact list associated with a device of a user responsible for said posting.

29. The method of claim 17, further comprising:
storing said job posting;
receiving a request for said posting from a network access device associated with a recipient of said notification; and
delivering said posting to said network access device.

30. The method of claim 17, further comprising:
removing said job posting after a period of time.
